(19) United States
(12) Patent Application Publication
(10) Pub. No.: US 2007/0222314 A1
(43) Pub. Date: Sep. 27, 2007

(54) Spindle motor having a fluid dynamic bearing system

(76) Inventor: Frank Drautz, Villingen-Schwenningen (DE)

Correspondence Address: COOPER & DUNHAM, LLP, 1185 AVENUE OF THE AMERICAS, NEW YORK, NY, 10036, US

(21) Appl. No.: 11/726,616

(22) Filed: Mar. 22, 2007

(30) Foreign Application Priority Data
Mar. 24, 2006 (DE) 10 2006 013 537.7

(51) Int. Cl. H02K 5/16; F16C 32/06

(52) U.S. Cl. 310/90; 384/107; 384/112

(57) ABSTRACT

The invention relates to a spindle motor having a fluid dynamic bearing system, used particularly for driving the storage disks of hard disk drives, having a baseplate, a stationary bearing bush disposed in an opening in the baseplate, a shaft rotatably supported in an axial bore in the bearing bush by means of the fluid dynamic bearing system, a hub connected to the shaft, and an electromagnetic drive system. The invention is characterized in that the shaft has a flange that is fixed in an opening in the hub and whose outside diameter is significantly larger than the smallest outside diameter of the shaft.

### TECHNICAL FIELD OF THE INVENTION

The invention relates to a spindle motor having a fluid dynamic bearing system according to the preamble of patent claim 1.

### PRIOR ART

In spindle motors having fluid dynamic bearing systems with rotating shafts, the connection between the hub and a completely straight or slightly stepped shaft is commonly effected using a press fit. Particularly small-scale spindle motor designs (microdrives) may also use a single-piece shaft/hub component.

In order to exploit as fully as possible the limited overall height that is available, one design frequently used in such small-scale form factors provides a fluid dynamic bearing system closed at the lower end having an outer, axial counterforce and only one fluid dynamic axial bearing formed between the hub and bearing bush, having a capillary seal disposed axially outwards and two radial bearings on a straight rotating shaft.

These kinds of spindle motors are revealed, for example, in U.S. Pat. No. 6,920,013 B2 or U.S. Pat. No. 6,888,278 B2. Here, an axial bearing is disposed between the lower surface of the hub and the upper surface of the bearing bush. A large number of individual components, such as a separate stopper ring, are additionally required in order to make up the bearing. The shaft is fixedly connected to the hub, it being necessary to further reduce the diameter of the shaft at the point of contact with the hub in order to ensure sufficient distance to the upper axial bearing. Particularly for small-scale bearings having correspondingly small shaft diameters of sometimes less than 2 mm, the connection of the shaft and hub is thus difficult to fabricate and is mechanically unstable especially with regard to vibrations and shocks. Due to their small joint length and small joint radius, the problem arises for small-scale bearings of the shaft being placed at a tilt in the hub, thus making the bearing incapable of carrying a load.

Other designs, such as US 2005/0025405 A1 provide a single-piece arrangement of shaft and hub. Here, however, the precise surfaces required by fluid bearings can only be produced in a very complex process, particularly since an annular part of the capillary seal that encloses the upper part of the shaft is formed integrally onto the hub. As a consequence, it is difficult to work the functional surfaces of the shaft using tools, especially since the surfaces are hidden and moreover very small. For magnetic storage drives having magnetic storage disks that have a diameter of one inch or less, the diameter of the shaft is in the order of magnitude, for example, of 1.8 to 2.0 mm.

Small-scale form factors (e. g. hard disk drives for notebooks) require even greater mechanical stability and motor stiffness vis-à-vis external forces and moments, as typically exerted on the motor, for example, on the production line during assembly of the complete hard disk drive or by external jarring on the hub (specification of more than 1000 times gravitational acceleration) by the mass of the storage disks.

At the same time, there is a demand for new motor concepts that consist of relatively few, easily manufactured parts and that allow sure and precise assembly of the entire motor (including alignment of the axis of the shaft to the hub and the axial and radial runout of the disk supporting surface of the hub). Moreover, greater variability in design is necessary for spindle motor form factors that are in ever greater demand and becoming increasingly smaller (including growing mobile applications) in order to meet such new customer requirements as increased dynamic stability, tighter tolerances, greater shock resistance, less power consumption, smaller dimensions, lower costs etc.

As indicated above, the present weak point of conventional motor designs has proved to be the press fit between the hub and the shaft, having typical diameters of approximately only 2 to 2.5 mm (in order to achieve low power consumption) and connection lengths in the range of approximately 1 to 2 mm (to ensure a low overall height), since it is not capable of preventing the hub from tilting vis-à-vis the shaft (a change in the axial runout of just a few micrometers being no longer acceptable) under the usual external forces and moments that are exerted. What is more, a reliable press fit for such small dimensions and a required axial runout remaining within a single-digit micrometer range can only be accomplished at great cost and effort and with a not-insignificant number of failures.

### SUMMARY OF THE INVENTION

The object of the invention is to provide a spindle motor having a fluid dynamic bearing system that consists of as few parts as possible, is comparatively simple to manufacture in a miniaturized form and that is insensitive to vibrations and severe shocks.

This object has been achieved according to the invention by a spindle motor having the characteristics outlined in claim 1.

Preferred embodiments of the invention and further advantageous characteristics are cited in the subordinate claims.

The invention describes a spindle motor having a fluid dynamic bearing system, used particularly for driving the storage disks of hard disk drives, having a baseplate, a stationary bearing bush disposed in an opening in the baseplate, a shaft rotatably supported in an axial bore in the bearing bush by means of the fluid dynamic bearing system, a hub connected to the shaft, and an electromagnetic drive system. The spindle motor is characterized in that the shaft has a flange that is fixed in an opening in the hub and whose outside diameter is significantly larger than the outside diameter of the shaft.

In other words, the shaft has an end that is widened by a flange and approximately T-shaped in cross-section. In addition to the radial bearing surfaces, the shaft preferably also has appropriate axial bearing surfaces at the flange, and is connected to the hub at the T-shaped flange radially outwards of the axial bearing. The shaft preferably forms a single bearing part that has all the functional surfaces of the moving bearing part. Thus any tilting of the hub with respect to the shaft does not impede the function of the bearing. Moreover, the radius of the joint between the T-shaped shaft and the hub is significantly larger than in conventional shaft/hub joints, thus making the press-out forces and vibration resistance also significantly greater.

With a T-shaped shaft according to the invention, preferably made of hardened steel and including all the functional bearing surfaces on the rotor, it is possible for the connection to the hub to be realized at a diameter many times larger than that of the shaft. Since the tilt resistance of the entire rotor is dependent to a large extent on the diameter of this connecting surface, the tilt resistance can be greatly increased while retaining the same outside dimensions as in conventional designs.

Moreover, thanks to the larger connecting surface, the connection between the hub and the T-shaped shaft piece can be more surely and precisely assembled. Some variations on the embodiment even make it possible to carry out the finishing work after assembly, which goes to practically eliminate failures resulting from the connecting process.

Furthermore, important motor tolerances such as the axial play of the bearing and the perpendicularity of the axial and radial bearing surfaces, are determined only by the precision of the T-shaped shaft piece which can be realized in high quality and at low cost as a single piece in the production process and is also much easier to achieve than with the present connecting processes. In addition, deformations that are caused by the disk holding device (mainly screwed centrally in the shaft) are reduced and are located in the sensitive bearing region under the hub in contrast to a conventional design having an axial bearing.

Moreover, the diameter of the shaft in the region of the axial bearing, which is the main contributor to any power loss of the bearing, can be reduced within certain limits almost independently of the other dimensions of the bearing.

On the other hand, it is of course possible to design a motor which is comparable to a conventional motor with respect to its mechanical stability and connecting characteristics, but which is realizable within substantially smaller geometric dimensions. Or the integral shaft/hub piece that is common in the smallest form factors and expensive to manufacture can be replaced by two parts that, as a whole, can be manufactured and assembled at lower cost. Here, it may also be important to provide the possibility of replacing the press fit at the outside diameter of the T-shaped shaft piece by a interference fit or a light transition fit and of reinforcing this by a (laser) weld.

Finally, the design of the rotor as described above provides greater variability in designing the seal of the fluid dynamic bearing. For example, due to the larger outside diameter, it is possible to press the hub from “below”, i.e. from the direction of the other end of the shaft, onto the T-shaped shaft piece, making it possible for the conically shaped capillary seal to have a larger angle towards the inside, or to integrate a stopper element that limits the axial play (a separate stopper ring no longer being necessary), resulting in an increase in the distance between the radial bearings and thus an increase in bearing stiffness.

### BRIEF DESCRIPTION OF THE DRAWINGS

On the left and right hand sides of the drawings, half sections of different embodiments of the spindle motors according to the invention (or parts thereof) are shown.

FIG. 1A shows an embodiment of parts of a spindle motor according to the invention having a stepped shaft flange.

FIG. 1B shows an embodiment of a part of a spindle motor according to the invention having a straight shaft flange and a hub pressed on from “below”.

FIG. 2A shows an embodiment of a part of a spindle motor according to the invention having an integrated stopper element.

FIG. 2B shows an embodiment of a part of a spindle motor according to the invention having a hub resting on the upper surface of the shaft flange.

FIG. 3A shows an embodiment of a part of a spindle motor according to the invention having a stepped shaft flange.

FIG. 3B shows an embodiment of a part of a spindle motor according to the invention having a straight shaft flange and an integrated stopper element.

FIG. 4 shows an embodiment of a spindle motor according to the invention having a connecting sleeve between the shaft flange and the hub.

FIG. 5A shows an embodiment of a spindle motor according to the invention that substantially corresponds to FIG. 1A.

FIG. 5B shows an embodiment of a spindle motor according to the invention that substantially corresponds to FIG. 1B.

FIG. 6A shows an embodiment of a spindle motor according to the invention having a straight shaft flange and an integrated stopper ring.

FIG. 6B shows an embodiment of a spindle motor according to the invention having a straight shaft flange and an integrated stopper ring.

### DESCRIPTION OF PREFERRED EMBODIMENTS OF THE INVENTION

The drawings show spindle motors or parts of spindle motors respectively that are substantially made up of the same components. These spindle motors can be used, for example, for driving a hard disk drive and generally comprise a stationary baseplate 6; 306; 406 on which a stator arrangement 7; 307; 407, consisting of a stator core and windings, is disposed. A shaft 1; 101; 201; 301; 401 is rotatably accommodated in an axial, cylindrical bore in a bearing bush 3; 103; 203; 303; 403. The bearing bush 3; 103; 203; 303; 403 is connected to the baseplate 6; 306; 406. The free end of the shaft 1; 101; 201; 301; 401 carries a hub 4; 104; 204; 304; 404 that can be bell-shaped and on which one or more storage disks (not illustrated) of the hard disk drive can be disposed and fixed. An annular permanent magnet 8; 108; 208; 308; 408 having a plurality of pole pairs is disposed at the lower inner or outer edge of the hub 4; 104; 204; 304; 404, an alternating electric field being applied to the pole pairs via a stator arrangement 7; 307; 407 spaced apart from them by means of an air gap, so that the hub 4; 104; 204; 304; 404 together with the shaft 1; 101; 201; 301; 401 is put into rotation. The shaft 1; 101; 201; 301; 401 together with the bearing bush 3; 103; 203; 303; 403 and an optional end plate disposed at one end of the shaft that takes the form of a thrust plate or a stopper plate 9; 109; 209; 309; 409, forms a fluid dynamic bearing system having radial bearing and axial bearing surfaces that are separated from each other by a bearing gap 5; 105; 205; 305; 405. The bearing gap is filled with a bearing fluid, such as a bearing oil. The construction and function of this kind of fluid dynamic bearing system is known to a person skilled in the art and shall not be described in more detail here. The bearing arrangement is sealed from below, i.e. in the region of the end plate, by a cover plate 10; 110, 210; 310; 410 for example, so that no bearing fluid can leak out in this region.

According to the invention, the shaft 1; 101; 201; 301; 401 is not designed to be entirely cylindrical with a diameter of the same size throughout, but rather has a flange at one end that has a substantially larger diameter, thus making the shaft appear somewhat T-shaped in cross-section. The shaft 1; 101; 201; 301; 401 is connected to the hub 4; 104; 204; 304; 404 in the region of the flange 2; 102; 202; 302; 402. To this effect, the hub 4; 104; 204; 304; 404 has an opening whose inside diameter corresponds approximately to the outside diameter of the flange 2; 102; 202; 302 404. The connection between the flange 2; 102; 202; 302; 402 and the hub 4; 104; 204; 304; 404 is preferably realized using a press fit, which can alternatively or additionally be bonded or welded, especially resistance or laser welded. The flange 2; 102; 202; 302; 402 is integrally formed as one piece with the shaft 1; 101; 201; 301; 401. The above-mentioned reference numbers apply equally to the reference numbers ending with “a” and “b”.

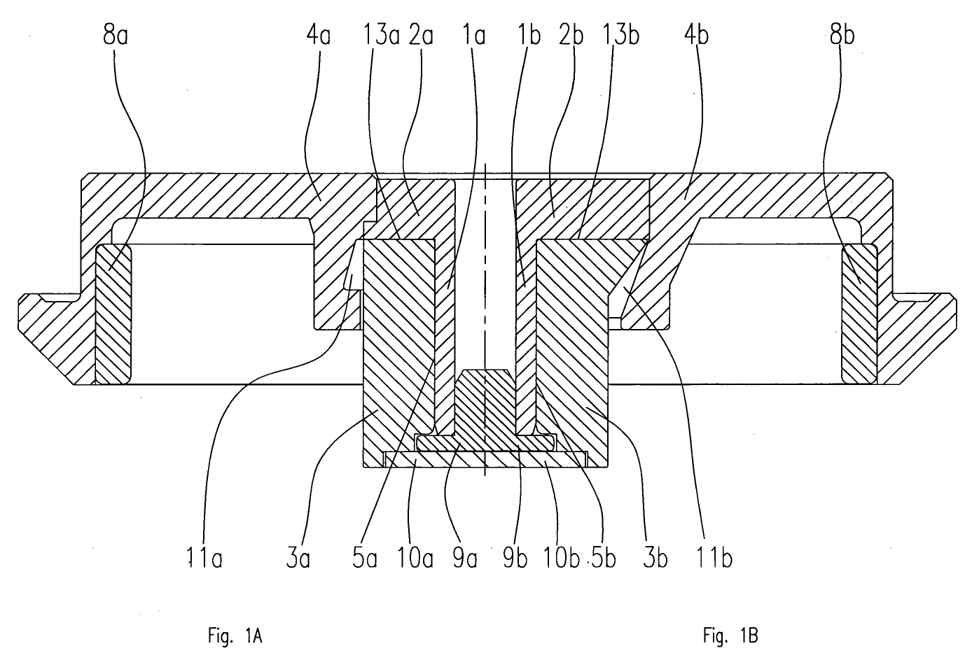

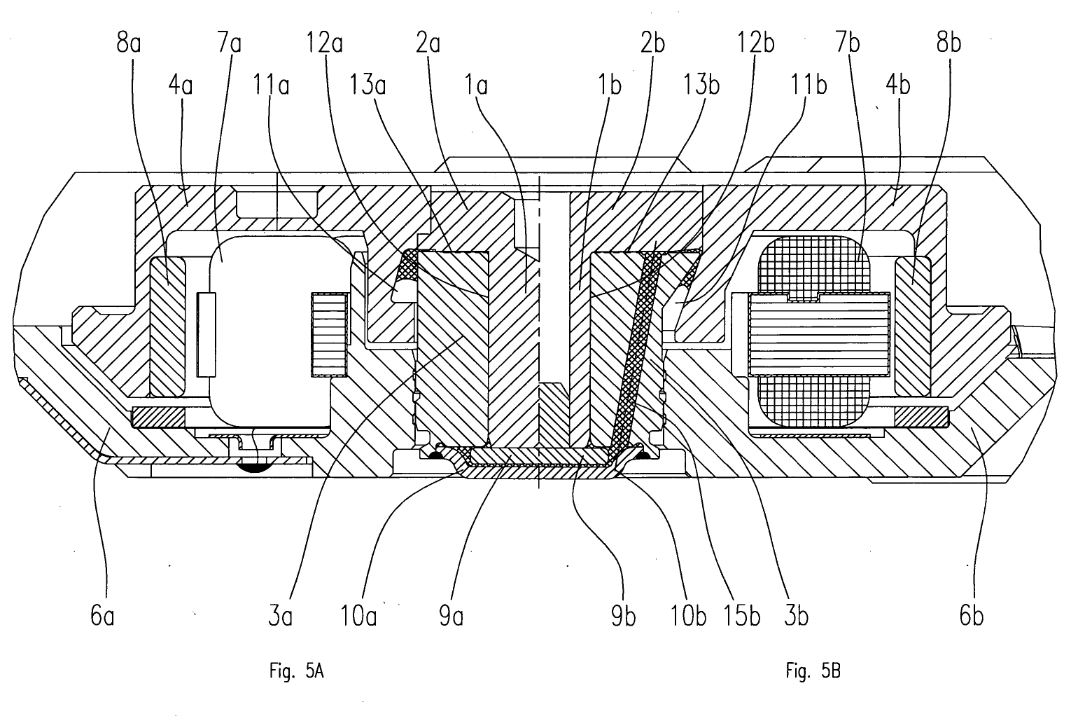

The FIGS. 1A or 5A respectively show a first embodiment of the invention in which the flange 2a is stepped and the hub 4a has a corresponding step so as to realize a precisely fitting, positive-locking connection between the flange 2a and the hub 4a. By means of this step that acts as a support, the hub 4a can withstand greater assembly torque, for example when the storage disks of a hard disk drive are being mounted, and particularly vis-à-vis the forces generated by the storage disk holding device. The bearing gap 5a, running for the most part between the outside diameter of the shaft 1a and the inside diameter of the bearing bush 3a, continues between the lower surface of the flange 2a and the upper end face of the bearing bush 3a, an axial bearing preferably being formed between the lower surface of the flange 2a and the opposing end face 3a of the bearing bush 3a. The bearing gap 5a ends in a conical space 11a that is designed as a capillary seal and acts as an equalizing volume and reservoir for the bearing fluid found in the bearing gap 5a. On the other side of the reservoir 11a, an annular axial projection of the hub 4a forms a capillary gap seal with the outside diameter of the bearing bush 3a, wherein the two opposing sealing surfaces of the hub 4a or of the bearing sleeve 3a may be provided with a grooved pattern that acts as a pumping pattern to support the sealing effect of the gap seal.

In contrast to FIGS. 1A and 5A, FIGS. 1B or 5B show an arrangement of the spindle motor having a flange 2b that is straight and pressed into an opening in the hub 4b. Another disparity with FIGS. 1A and 5A lies in the design of the space 11b in extension of the bearing gap 5b. The space 11b is formed between a slanted outer circumference of the bearing bush 3b and a slanted inner circumference of an annular projection of the hub 4b and tapers conically outwards from the bearing gap 5b. The space 11b extends radially inwards at an angle of approximately 45° to the rotational axis of the bearing. The substantially longer space 11b compared to FIG. 1A and the angularity of this space 11b to the rotational axis, results in the fact that this spindle motor has particularly high shock resistance.

The possibility of pressing the hub from below onto the shaft means that the space 11b can be designed substantially longer compared to FIG. 1A and inclined inwards at a larger angle to the rotational axis. This affords the capillary seal formed by the space 11b significantly increased shock resistance against any external shock acting both horizontally as well as vertically. In operating status, the fluid is pressed into the interior of the bearing by centrifugal force.

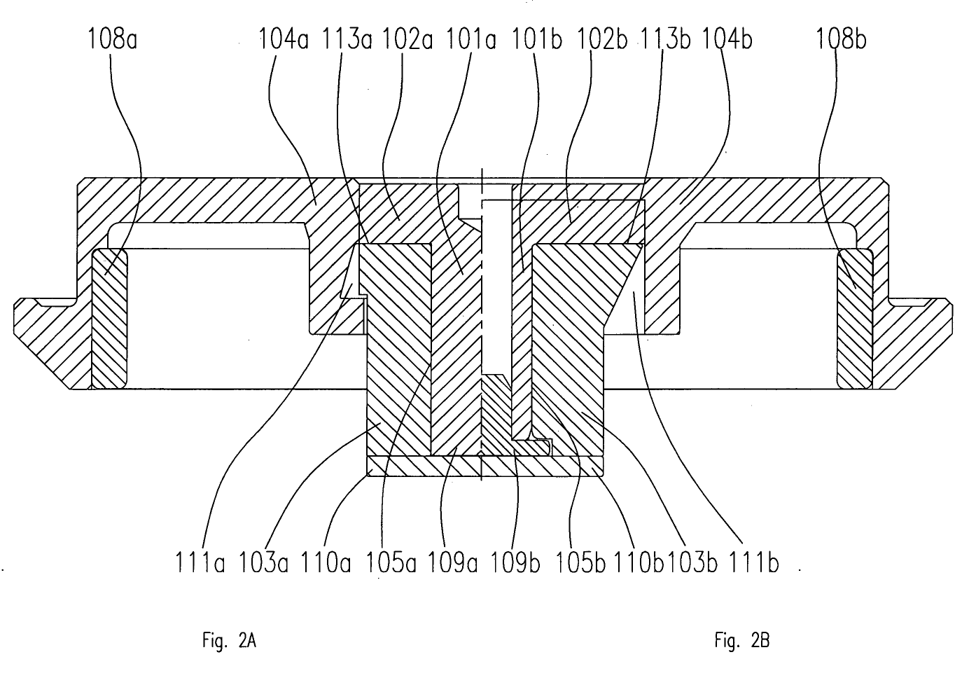

FIG. 2A shows a spindle motor or a part of a spindle motor respectively that has a similar design as in FIG. 1A. Here, however, the flange 102a is straight, which means it is designed without a step. Instead, the bearing bush 103a has a step in the region of the space 111a that acts as a stop for an annular projection of the hub 104a which forms a capillary gap seal with the bearing bush 103a on the other side of the space 111a. This stop moreover acts as a stopper element and prevents the rotating part of the spindle motor, i.e. the shaft 101a together with the hub 104a, from coming away from the stationary part 103a.

As likewise shown in FIG. 1B, there is also the possibility here of pressing the hub onto the shaft from below the bearing whereby the stop acts as the element that limits the axial play of the rotor, i.e. displacement of the shaft 101a together with the hub 104a vis-à-vis the stationary bearing bush 103a is restricted, thus making a separate stopper element superfluous.

FIG. 2B shows an embodiment of the spindle motor in which the shaft 101b has a straight flange 102b that is accommodated in a recess in the hub 104b. The recess is designed such that the hub 104b rests on the upper end face of the flange 102b. This method of connecting the flange 102b and the hub 104b results not only in increased assembly stability but also in lower runout for the hub 104b after assembly since the supporting surfaces can be fabricated very precisely. Here again a space 111b is disposed beyond the bearing gap 105b. The space 111b is formed by a slanted outside diameter of the bearing bush 103b and a projection of the hub 104b running approximately parallel to the rotational axis. The space 111b acts as an equalizing volume and a capillary seal.

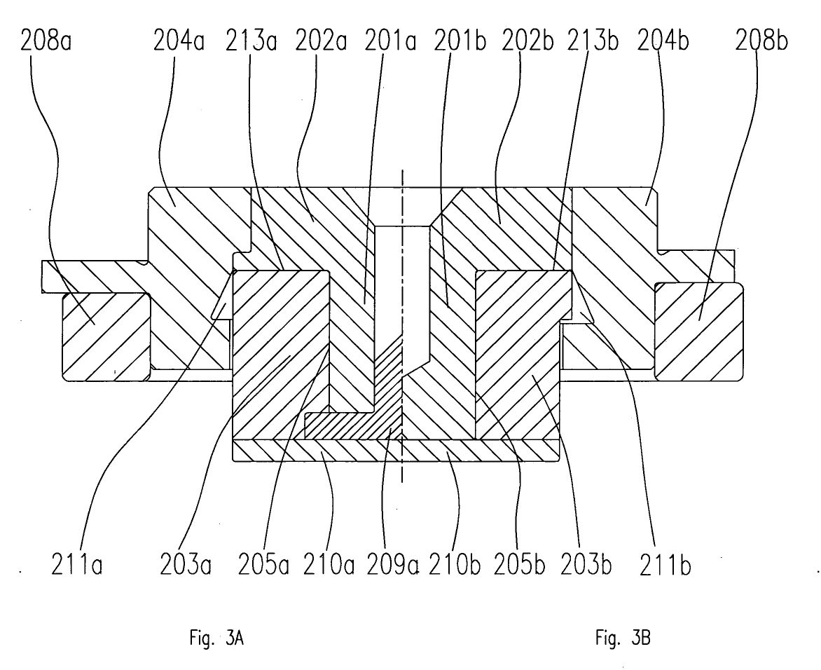

FIG. 3A shows a further embodiment of a spindle motor according to the invention that corresponds in principle to the embodiment according to FIG. 1A. Here again, the hub 204a is carried by a stepped flange 202a. In contrast to the embodiment according to FIG. 1A or FIG. 5A respectively, the spindle motor in FIG. 3A is designed as an inner rotor motor, i.e. the stator arrangement (not illustrated) is disposed radially outside the permanent magnet 208a, which is particularly advantageous for small-scale motors since here the entire stator arrangement cannot be disposed below the hub, whereas in FIG. 5A the stator arrangement is disposed within the permanent magnet.

FIG. 3B shows a similar arrangement to FIG. 3A having a shaft flange 202b without a step although a step is provided at the outside diameter of the bearing bush 203b, this step acting as a stop for an axial projection of the hub 204b whose inner surface together with the outer surface of the bearing bush 203b forms a capillary gap seal.

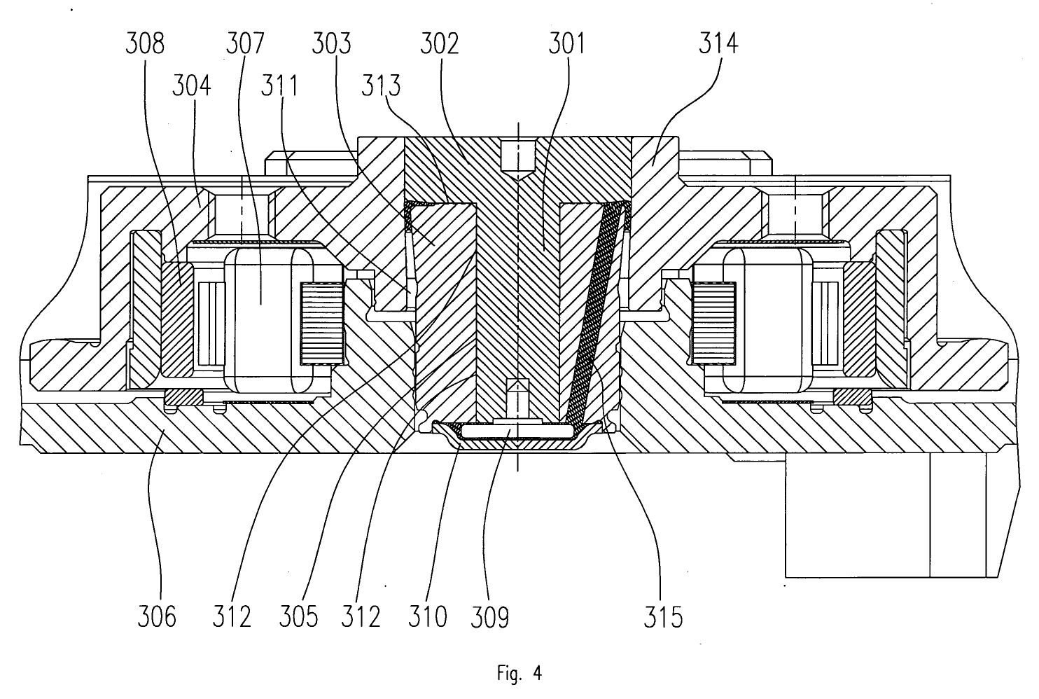

In FIG. 4, the T-shaped shaft 301 is integrally formed as a single piece with a flange 302 and connected at the outside diameter to the hub 304. The hub 304 is given a sleeve-shaped projection 314 by which a space 311 is created that acts as a reservoir and equalizing volume for the bearing fluid which circulates in a bearing gap 305 and forms a capillary seal.

Here, it is possible to finish the supporting surface of the magnetic storage disks after the assembly of the hub 304 and the shaft 301 using machining processes, which means that extremely low axial runout of the hub 304 can be achieved.

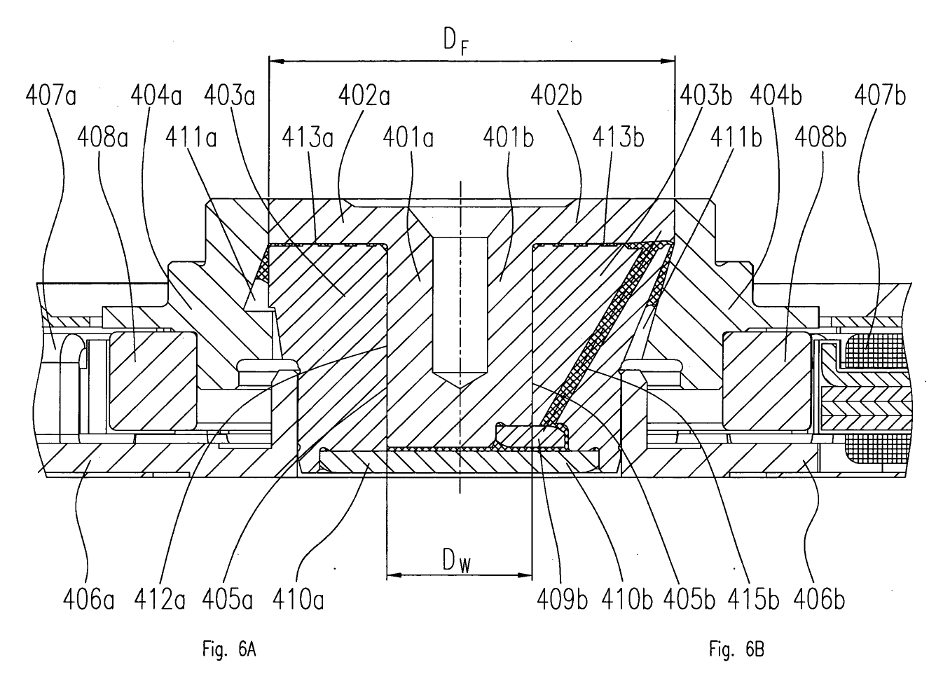

FIG. 6A shows an embodiment of a spindle motor according to the invention that substantially corresponds to the embodiment according to FIG. 3B, having a stepped bearing sleeve 403a and a rotor designed as an inner rotor motor, consisting of the shaft 401a together with the flange 402a on which the hub 404a is fixed.

FIG. 6B shows an embodiment that, analogous to FIG. 1B, has a space 411b which runs at an angle of some 45° to the rotational axis of the bearing and thus affords the bearing high shock resistance. Here again, the rotor is designed as an inner rotor motor, the stator arrangement 407b enclosing the rotor. In FIGS. 6A and 6B, the shaft flanges 402a and 402b are relatively flat in design so that there is a relatively large bearing length and thus a large spacing between the two radial bearings that are formed by the surfaces of the shaft 401a and of the bearing bush 403a or 401b and 403b respectively.

The feature that all the illustrated embodiments of the invention have in common is a shaft flange 2; 102; 202; 302; 402 that has a significantly larger diameter D_{F} compared to the smallest diameter of the shaft D_{W}, the larger diameter D_{F} being preferably at least 1.5 times to twice as large. As a result, the connection between the hub and the shaft piece or shaft flange respectively has a larger connecting surface and a larger connecting diameter, so that a more precise and stress resistant connection between the hub and the shaft or shaft flange respectively can be realized.

As an alternative to the embodiments shown in FIGS. 2A, 3B and 6A in which a stopper element is provided between the hub and the bearing bush, end plates 9a, 9b, 109b, 209a, 309a are provided at the lower end of the shaft in the other embodiments, the end plates taking on the same function of holding the shaft within the bearing bush. The end plates can be connected to the shaft by means of a screwed joint, by pressing on or by a welded joint, particularly by means of laser or resistance welding, and they can be designed as a disk or ring.

In the spindle motors according to FIGS. 4, 5B and 6B a recirculation channel. 315, 15, or 415 is shown in the bearing bush 303b, 3b or 403b that substantially runs in an axial direction and is filled with bearing fluid. The recirculation channel 315, 15 or 415 connects a “lower” region of the bearing gap 305, 5b or 405b between the thrust plate 309, 9b or 409b and the cover plate 310, 10b or 410b to an “upper” region of the bearing gap between the end face of the bearing bush 303, 3b or 403b and the flange 302, 2b or 402b. This goes to produce a circular flow of the bearing fluid that circulates through the bearing gap and the recirculation channel.

### IDENTIFICATION REFERENCE LIST

1a,b Shaft
2a,b Flange
3a,b Bearing bush
4a,b Hub
5a,b Bearing gap
6a,b Baseplate
7a,b Stator arrangement
8a,b Permanent magnet
9a,b End plate
10a,b Cover plate
11a,b Space
12a,b Radial bearing
13a,b Axial bearing
15 Recirculation channel
101a,b Shaft
102a,b Flange
103a,b Bearing bush
104a,b Hub
105a,b Bearing gap
108a,b Permanent magnet
109a,b End plate
110a,b Cover plate
111a,b Space
113a,b Axial bearing
201a,b Shaft
202a,b Flange
203a,b Bearing bush
204a,b Hub
205a,b Bearing gap
208a,b Permanent magnet
209a End plate
210a,b Cover plate
211a,b Space
213a,b Axial bearing
301 Shaft
302 Flange
303 Bearing bush
304 Hub
305 Bearing gap
306 Baseplate
307 Stator arrangement
308 Permanent magnet
309 Thrust plate
310 Cover plate
311 Space
312 Radial bearing
313 Axial bearing
314 Sleeve
315 Recirculation channel
401a,b Shaft
402a,b Flange
403a,b Bearing bush
404a,b Hub
405a,b Bearing gap
406a,b Baseplate
407a,b Stator arrangement
408a,b Permanent magnet
409b Thrust plate
410a,b Cover plate
411a,b Space
412a,b Radial bearing
413a,b Axial bearing
415 b Recirculation channel
D_{F} Flange diameter
D_{W} Shaft diameter

1. A spindle motor having a fluid dynamic bearing system, used particularly for driving the storage disks of hard disk drives, having a baseplate (6; 306; 406), a stationary bearing bush (3; 103; 203; 303; 403) disposed in an opening in the baseplate, a shaft (1; 103; 203; 303; 403) rotatably supported in an axial bore in the bearing bush by means of the fluid dynamic bearing system, a hub (4; 104; 204; 304; 404) connected to the shaft, and an electromagnetic drive system (7, 8; 307, 308; 407, 408), characterized in that the shaft has a flange (2; 102; 202; 302; 402) that is fixed in an opening in the hub and whose outside diameter is significantly larger than the outside diameter of the shaft.

2. A spindle motor according to claim 1, characterized in that the outside diameter of the flange (2; 102; 202; 302; 402) is at least 1.5 times the smallest diameter of the shaft.

3. A spindle motor according to claim 1, characterized in that the outside diameter of the flange (2; 102; 202; 302; 402) corresponds substantially to the outside diameter of the bearing bush.

4. A spindle motor according to claim 1, characterized in that the flange (2; 102; 202; 302; 402) is integrally formed as a single piece with the shaft.

5. A spindle motor according to claim 1, characterized in that a space (11; 111; 211; 311; 411) formed by the interfaces between the hub (4; 104; 204; 304; 404) and the bearing bush (3; 103; 203; 303; 403) is conical in cross-section.

6. A spindle motor according to claim 1, characterized in that the outside diameter of the flange (2; 102; 202; 302; 402) is designed with a step.

7. A spindle motor according to claim 1, characterized in that the flange (2;. 102; 202; 302; 402) is connected to the hub (4; 104; 204; 304; 404) by means of a press fit.

8. A spindle motor according to claim 1, characterized in that an axial bearing (13; 113; 213; 313; 413) is formed between the flange and the bearing bush (3; 103; 203; 303; 403).

9. A spindle motor according to claim 1, characterized in that a recirculation channel (15; 315; 415) connects one end face of the bearing bush (3; 303; 403) to its other end face by means of which pressure is equalized in the adjoining regions of a bearing gap (5; 305; 405).

10. A spindle motor according to claim 1, characterized in that the flange (2; 102; 202; 302; 402) is connected to the hub (4; 104; 204; 304; 404) by means of a welded joint.

11. A spindle motor according to claim 1, characterized in that the hub (4; 104; 204; 304; 404) is pressed onto the shaft or the flange respectively (2; 102; 202; 302; 402) from below.

12. A spindle motor according to claim 1, characterized in that the axial play of the shaft (1; 101; 201; 301; 401) is restricted by a stopper element that is formed by parts of the hub (4; 104; 204; 304; 404) and of the bearing bush (3; 103; 203; 303; 403).

13. A spindle motor according to claim 12, characterized in that the axial play of the shaft (1; 101; 201; 301; 401) is restricted by an end plate (9; 109; 209; 309; 409) that is disposed at one end of the shaft.

14. A spindle motor according to claim 13, characterized in that the end plate is connected to the shaft (1; 101; 201; 301; 401) by a screwed, pressed, bonded or welded joint.

15. A spindle motor according to claim 1, characterized in that the finishing work to the surfaces of the shaft and/or the hub is carried out after the two components have been joined.

16. A hard disk drive having a spindle motor according to claim 1.
